(19) United States
(12) Patent Application Publication
(10) Pub. No.: US 2015/0066581 A1
(43) Pub. Date: Mar. 5, 2015

(54) DEVICE FOR INCREASING SELF-SERVICE ADOPTION

(71) Applicant: Accenture Global Services Limited, Dublin (IE)

(72) Inventors: Subramanian H. CHANDRASHEKARAPURAM, Fremont, CA (US); Angela GORDON, Vancouver, CA (US)

(73) Assignee: Accenture Global Services Limited, Dublin (IE)

(21) Appl. No.: 14/013,731

(22) Filed: Aug. 29, 2013

(51) Int. Cl. G06Q 30/02

(52) U.S. Cl. CPC G06Q 30/0201
USPC 705/7.29

(57) ABSTRACT

A device is configured to receive customer information associated with a set of customers and determine a set of self-service customers, of the set of customers, based on the customer information. The set of self-service customers may be associated with a likelihood, of participating in future self-service transactions, that is greater than a first threshold. The device is configured to determine attribute information associated with the set of self-service customers and identify a set of target customers, of the set of customers, based on the attribute information. The set of target customers may be associated with a likelihood, of participating in future self-service transactions, that is less than a second threshold. The device is configured to determine target information based on identifying the set of target customers, and to provide the target information. The target information may include information that identifies the set of target customers.

### BACKGROUND

Businesses may gather information about customers, such as information about transactions between customers and the businesses, demographic information associated with the customers, or the like. A business may favor certain types of transactions, such as self-service transactions, over other types of transactions. Self-service transactions may include transactions that do not require a direct interaction with a human agent.

### SUMMARY

According to some possible implementations, a device may receive customer information associated with a set of customers, and may determine a set of self-service customers, of the set of customers, based on the customer information. The set of self-service customers may be associated with a likelihood, of participating in future self-service transactions, that is greater than a first threshold. The device may determine attribute information associated with the set of self-service customers, and may identify a set of target customers, of the set of customers, based on the attribute information. The set of target customers may be associated with a likelihood, of participating in future self-service transactions, that is less than a second threshold. The device may determine target information based on identifying the set of target customers, and may provide the target information. The target information may include information that identifies the set of target customers.

According to some possible implementations, a computer-readable medium may store instructions that cause one or more processors to receive customer information associated with a set of customers, and may determine a set of self-service customers, of the set of customers, based on the customer information. The set of self-service customers may be associated with a set of self-service rates that is greater than a first threshold. The set of self-service rates may be associated with a set of self-service transactions, of a set of transactions. The instructions may cause the one or more processors to determine attribute information associated with the set of self-service customers, and to identify a set of target customers, of the set of customers, based on the attribute information. The set of target customers may be associated with a likelihood, of participating in future self-service transactions, that is less than a second threshold. The instructions may cause the one or more processors to determine target information based on identifying the set of target customers, and to provide the target information. The target information may include information that identifies the set of target customers.

According to some possible implementations, a method may include receiving customer information associated with a set of customers and determining a set of self-service customers, of the set of customers, based on the customer information. The set of self-service customers may be associated with a likelihood, of participating in future self-service transactions, that satisfies a first threshold. The method may include determining attribute information associated with the set of self-service customers and identifying a set of target customers, of the set of customers, based on the attribute information. The set of target customers may be associated with a likelihood, of participating in future self-service transactions, that is less than a second threshold. The method may include determining target information based on identifying the set of target customers, and providing the target information. The target information may include information that identifies the set of target customers.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for determining target customers for self-service transactions;

FIGS. 5A-5C are diagrams of an example implementation relating to the example process shown in FIG. 4;

FIGS. 6A-6B are diagrams of another example implementation relating to the example process shown in FIG. 4; and

FIG. 7 is a diagram of yet another example implementation relating to the example process shown in FIG. 4.

### DETAILED DESCRIPTION

The following detailed description of example implementations refers to the accompanying drawings. The same reference numbers in different drawings may identify the same or similar elements.

A customer may interact with a business for a variety of purposes, such as to access information regarding a product, pay a bill, modify a service plan, receive customer support, or the like. Some customers may interact with the business via an agent of the business (e.g., a salesperson, a call center representative, a customer service agent, etc.). Other customers may interact with the business via an automated process (e.g., an automated kiosk, an automated website, an interactive voice response (“IVR”) system, etc.). Automated transactions may be more efficient, less prone to error, and more cost-effective than transactions involving an agent of the business.

A business may encourage customers that rarely interact with the business via automated processes to more frequently engage in self-service transactions (e.g., transactions that do not involve a direct transaction with a human agent). However, identifying those customers most likely to increase their rate of self-service transactions may be challenging. Implementations described herein may allow a business to identify customers likely to increase a rate of self-service transactions, and may provide information useful for designing a marketing campaign, incentive program, educational program, or the like.

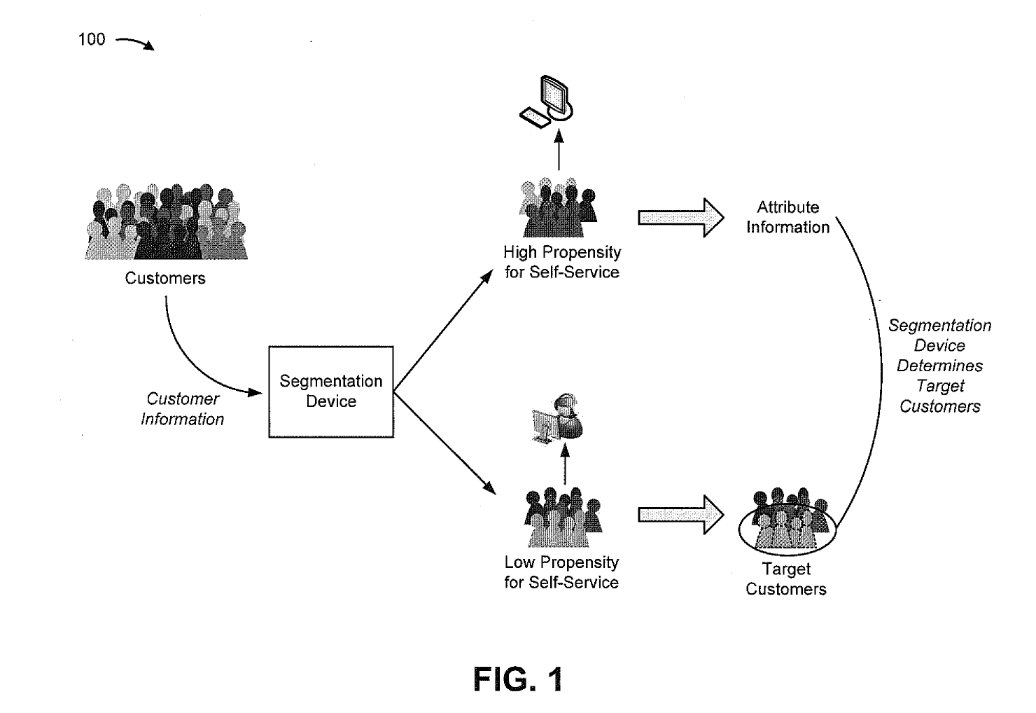

FIG. 1 is a diagram of an overview of an example implementation 100 described herein. As shown in FIG. 1, example implementation 100 may include a set of customers and a segmentation device.

As shown in FIG. 1, the segmentation device may receive customer information associated with the set of customers. The customer information may include information about the set of customers (e.g., demographic information), information about past transactions between the set of customers and a company (e.g., a transaction history), or the like. Based on the customer information, the segmentation device may determine a set of customers having a high propensity for self-service transactions (e.g., customers likely to engage in frequent self-service transactions in the future). A self-service transaction may include a transaction that does not require a direct interaction between a customer and a human agent (e.g., a transaction completed at an automated kiosk, an automated website, via an interactive voice response (“IVR”) system, etc.). Likewise, the segmentation device may determine a set of customers having a low propensity for self-service transactions (e.g., customers unlikely to engage in frequent self-service transactions in the future).

As further shown in FIG. 1, the segmentation device may determine attribute information, from the customers having a high propensity for self-service transactions, based on the customer information. The attribute information may include attributes shared by the set of high propensity self-service customers associated with high self-service rates. Based on the attribute information, the segmentation device may identify a set of target customers, of the set of low propensity self-service customers. The set of target customers may include customers with attributes similar to the set of high self-service customers (e.g., customers who are likely to become high self-service customers). In this manner, the segmentation device may identify those customers likely to migrate from the set of low self-service customers to the set of high self-service customers. Based on information associated with the customers most likely to migrate, a user of the segmentation device may design a campaign targeted to these customers, such as a marketing campaign, a survey, an incentive offered to customers, educational material provided to customers, or the like. Furthermore, results of the campaign (e.g., successful or unsuccessful conversions to a higher self-service segment) may be provided as input in an iterative learning process to improve future conversions of customers to self-service options.

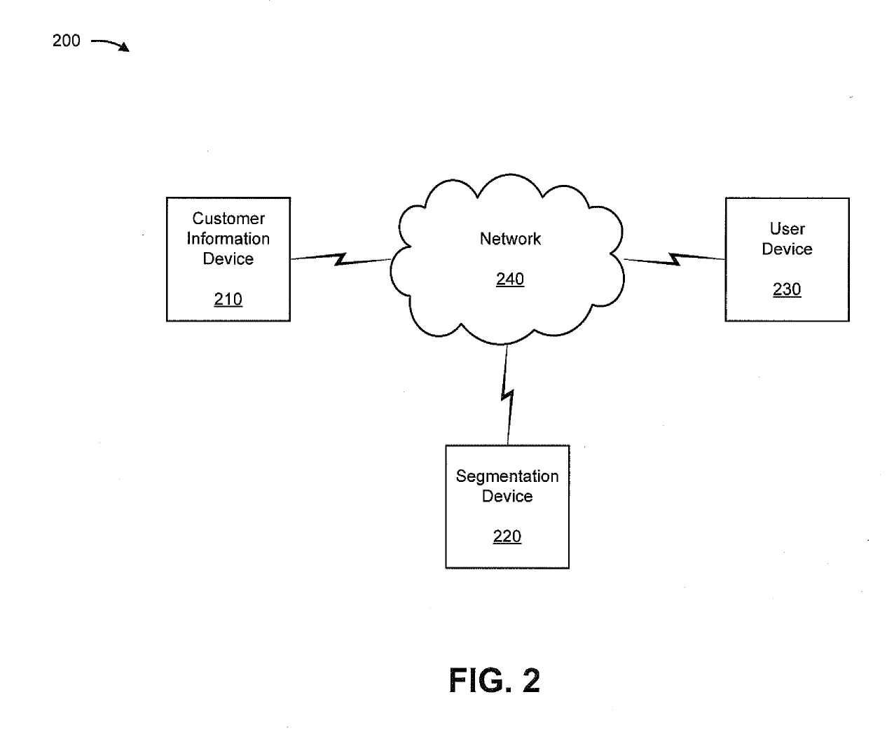

FIG. 2 is a diagram of an example environment 200 in which systems and/or methods described herein may be implemented. As shown in FIG. 2, environment 200 may include a customer information device 210, a segmentation device 220, a user device 230, and a network 240. Devices of environment 200 may interconnect via wired connections, wireless connections, or a combination of wired and wireless connections.

Customer information device 210 may include a device capable of receiving, generating, processing, storing, and/or providing information, such as information associated with a customer. For example, customer information device 210 may include one or more computation or communication devices, such as a server device. In some implementations, customer information device 210 may include a cash register (e.g., associated with a store), a kiosk, a call center, a website, an IVR system, or the like. Customer information device 210 may receive information from and/or transmit information to segmentation device 220 and/or user device 230.

Segmentation device 220 may include a device capable of receiving information associated with a set of customers and determining target customers based on the information. For example, segmentation device 220 may include a desktop computer, a laptop computer, a tablet computer, handheld computer, a server device, or a similar device. Segmentation device 220 may receive information from and/or transmit information to customer information device 210 and/or user device 230.

User device 230 may include a device capable of receiving and/or displaying information associated with the target customers. For example, user device 230 may include a computing device (e.g., a desktop computer, a laptop computer, a tablet computer, handheld computer), a mobile telephone (e.g., a smartphone), or a similar device. User device 230 may receive information from and/or transmit information to customer information device 210 and/or segmentation device 220.

Network 240 may include one or more wired and/or wireless networks. For example, network 240 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks.

The number of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

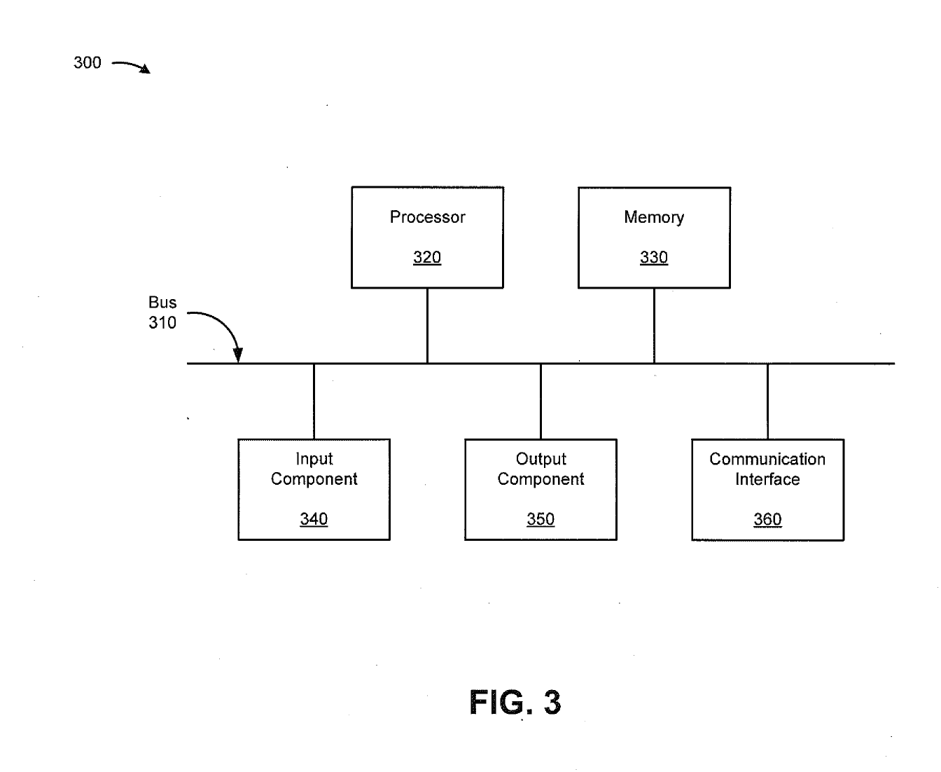

FIG. 3 is a diagram of example components of a device 300. Device 300 may correspond to customer information device 210, segmentation device 220, and/or user device 230. Additionally, or alternatively, each of customer information device 210, segmentation device 220, and/or user device 230 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing component (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (“LEDs”), etc.).

Communication interface 360 may include a transceiver-like component, such as a transceiver and/or a separate receiver and transmitter, that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

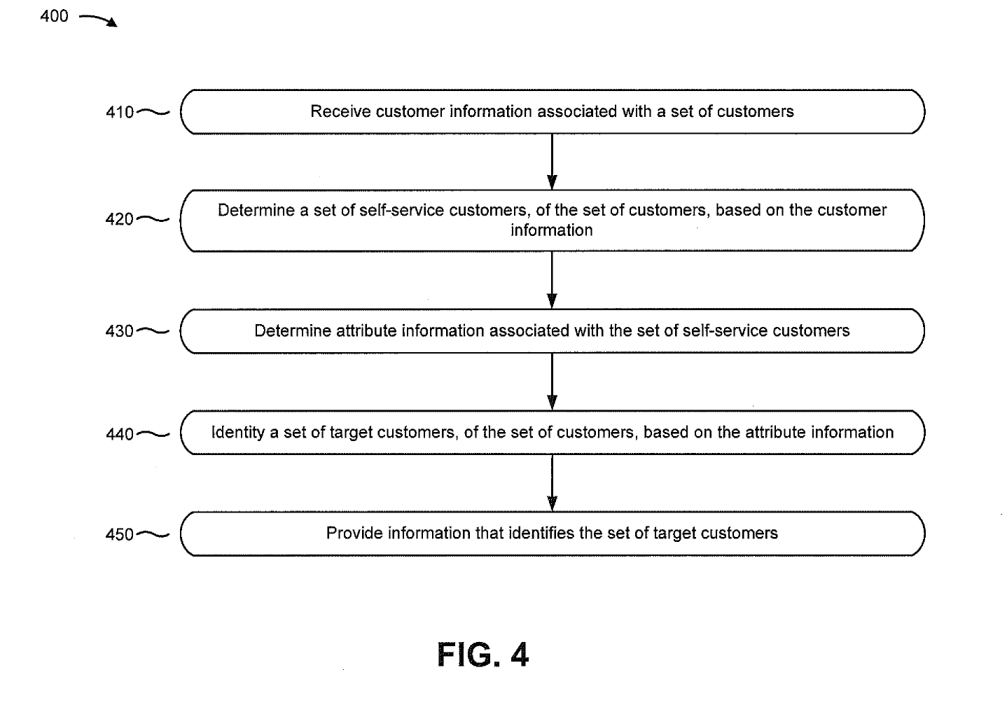

FIG. 4 is a flow chart of an example process 400 for determining target customers for self-service. In some implementations, one or more process blocks of FIG. 4 may be performed by segmentation device 220. Additionally, or alternatively, one or more process blocks of FIG. 4 may be performed by another device or a group of devices separate from or including segmentation device 220, such as customer information device 210 and/or user device 230.

As shown in FIG. 4, process 400 may include receiving customer information associated with a set of customers (block 410). For example, segmentation device 220 may receive customer information from customer information device 210.

The customer information may include information associated with a customer. For example, the customer information may include a transaction history. The transaction history may include information that identifies a prior interaction between the customer and a business (e.g., an enterprise, an association, a retailer, a firm, a partnership, etc.). For example, the transaction history may include information associated with a purchase by the customer (e.g., a product, a service, etc.), a payment by the customer (e.g., a payment type, a payment amount, an indication of whether the payment was overdue, a pattern of overdue payments, a billing method, etc.), a communication between the customer and the business (e.g., a sales inquiry, a service call, an interaction with an agent of the business, etc.), a transaction type (e.g., a bill payment, a billing inquiry, a maintenance or service request, a request to start or stop service, a request for information, a purchase, a return, a complaint, etc.), a time associated with the transaction (e.g., a date the transaction occurred, a time the transaction occurred, a time of day the transaction occurred, etc.), or the like. Additionally, or alternatively, the transaction history may include information associated with a use of an incentive program by the customer (e.g., a rebate, a coupon, a discount, etc.).

The customer information may identify one or more transaction channels used by the customer, in some implementations. The transaction channel may include a channel by which a customer interacts with the business. For example, the transaction channel may include use of a call center, a website, a kiosk, an interactive voice response (“IVR”) system, an email service, a postal service, or the like.

In some implementations, the customer information may include demographic information associated with a customer, such as an age, a gender, a marital status, an education level, a language, an employment status, an income level, or the like. Additionally, or alternatively, the customer information may include information that identifies a location associated with the customer (e.g., an address, a postal code, an area code, etc.), a dwelling type associated with the customer (e.g., whether the customer lives in a house, an apartment, a townhome, etc.), or the like. In some implementations, the customer information may include financial information associated with the customer, such as a credit history, a credit score, an indication of whether the customer owns a home, a home value, or the like. Additionally, or alternatively, the customer information may include profile information associated with the customer (e.g., a set of user preferences, identification information, a list of products or services that the customer has purchased, etc.).

Customer information may include information associated with a campaign, in some implementations. For example, the customer information may include a result of a campaign, such as a marketing campaign, an incentive, an educational campaign, or the like. A result of a campaign may include whether the campaign was successful or unsuccessful at causing a customer to migrate from one self-service segment to another self-service segment (e.g., a higher segment). As another example, the customer information may include information obtained via the campaign, such as information obtained via a survey. Additionally, or alternatively, the customer information may include a type of the campaign, a communication medium via which the campaign was delivered to a customer (e.g., e-mail, phone, mail, web, etc.). In this way, results of a campaign targeting customers for increased self-service may be used for continuous learning and refinement of future campaigns.

In some example implementations, the business may include a utilities provider (e.g., an electric company, a gas company, a water provider, etc.). The customer information may include usage information (e.g., an amount of electricity used by the customer, an amount of gas used by the customer, an amount of water used by the customer, etc.), profile information (e.g., a service plan associated with the customer), product information (e.g., an electric meter type associated with the customer, a gas meter type associated with the customer, a thermostat sold to the customer, an energy management product purchased by the customer, etc.), incentive information (e.g., a rebate received by the customer, an income credit received by the customer, etc.), or the like. Additionally, or alternatively, the customer information may include payment history information (e.g., whether the customer has paid a bill online, whether the customer is associated with a balanced payment plan, whether the customer has signed up for electronic billing), interaction information (e.g., a history of outbound interactions with the business, a history of inbound interactions with the business, etc.), energy conservation information (e.g., whether the customer owns an electric vehicle, whether the customer owns a hybrid vehicle, whether the customer participates in a renewable energy plan, whether the customer has a gas or electric water heater, etc.), or the like.

As further shown in FIG. 4, process 400 may include determining a set of self-service customers, of the set of customers, based on the customer information (block 420). For example, the set of self-service customers may include customers that have engaged in and/or are likely to engage in future self-service transactions (e.g., customers with a likelihood, of engaging in future self-service transactions, above a threshold likelihood). In some implementations, a self-service transaction may include a transaction that does not require a human agent (e.g., other than the customer). For example, a self-service transaction may include a transaction performed using an automated kiosk, an automated website, an interactive voice response (“IVR”) system, a smartphone application, or the like. Additionally, or alternatively, a self-service transaction may include an interaction that does not require a direct interaction between the customer and the human agent. In some implementations, a self-service transaction may include a transaction that does not require any human intervention and/or supervision to complete.

Segmentation device 220 may determine the self-service customers based on self-service rates associated with the set of customers, in some implementations. For example, segmentation device 220 may determine a self-service rate associated with a customer of the set of customers. The self-service rate may include a measure of how frequently the customer participates in a self-service transaction. For example, the self-service rate may include a percentage of self-service transactions, of a total number of transactions, associated with the customer during a period of time (e.g., a month, a quarter, a year, etc.).

Segmentation device 220 may determine the self-service rate based on the customer information, in some implementations. For example, segmentation device 220 may receive the customer information from customer information device 210 (e.g., a transaction history associated with the customer). Segmentation device 220 may determine a quantity of transactions associated with the customer during a period of time. Segmentation device 220 may determine a quantity of self-service transactions, of the quantity of transactions, based on the customer information. Additionally, or alternatively, segmentation device 220 may determine the self-service rate based on a transaction type (e.g., a self-service rate for a particular type of transaction), a time associated with the transaction (e.g., a particular time period during which a customer performed self-service transactions), or the like.

Segmentation device 220 may group the set of customers into one or more self-service segments based on the self-service rate, in some implementations. For example, segmentation device 220 may group customers associated with a self-service rate that satisfies one or more thresholds into one or more segments. For example, segmentation device 220 may determine a high self-service segment (e.g., a segment of customers associated with self-service rates greater than 80%), a medium self-service segment (e.g., a segment of customers associated with self-service rates between 50% and equal to, but not greater than, 80%), a low self-service segment (e.g., a segment of customers associated with self-service rates greater than 20% and equal to, but not greater than, 50%), a very low self-service segment (e.g., a segment of customers associated with self-service rates equal to, but not greater than, 20%), or the like. In some implementations, segmentation device 220 may group the customers into segments per transaction type, per time period, etc.

Segmentation device 220 may determine a migrating self-service segment based on the customer information, in some implementations. A migrating self-service segment may include a segment of customers that migrate between two or more self-service segments (e.g., customers that migrate from the medium self-service segment to the high self-service segment, customers that migrate from the low self-service segment to the medium self-service segment, etc.). For example, segmentation device 220 may determine that a segment of customers associated with a medium self-service rate (e.g., customers in the medium-service segment) during a first period of time (e.g., a first month, a first quarter, etc.) may be associated with a different self-service rate (e.g., a low self-service rate, a high self-service rate, etc.) during a subsequent period of time (e.g., a second month, a second quarter, etc.). In this manner, segmentation device 220 may determine that the customers have migrated between self-service segments. Additionally, or alternatively, segmentation device 220 may determine a steady self-service segment (e.g., a segment of customers that remains in the same self-service segment during multiple time periods).

Segmentation device 220 may determine the set of self-service customers based on a propensity score, in some implementations. For example, the propensity score may include a score (e.g., a number, a value, a probability, etc.) that estimates a likelihood that the customer will engage in a future self-service transaction. Segmentation device 220 may determine the propensity score based on the customer information and/or the self-service rate. In some implementations, segmentation device 220 may rank the set of customers based on the propensity scores (e.g., ranked in percentiles). Segmentation device 220 may determine the set of self-service customers based on the ranked propensity scores (e.g., based on the likelihood of the self-service customers to engage in future self-service transactions).

In some implementations, segmentation device 220 may determine the propensity score based on a statistical model (e.g., a regression analysis), such as a multinomial logistic regression. For example, a customer may be associated with customer information (e.g., independent variables, features, input variables, etc.) and a likelihood of engaging in a future self-service transaction (e.g., a dependent variable, a response variable, an output variable, etc.). Based on the multinomial logistic regression, segmentation device 220 may determine a propensity model. The propensity model may identify a relationship between the customer information and the likelihood of engaging in a future self-service transaction (e.g., the propensity model may identify which portions of the customer information best predicts whether the customer will engage in a future self-service transaction). Segmentation device 220 may group the set of customers into one or more self-service segments based on the multinomial logistic regression and/or the propensity model.

As further shown in FIG. 4, process 400 may include determining attribute information associated with the set of self-service customers (block 430). For example, segmentation device 220 may determine attribute information associated with customers likely to participate in future self-service transactions (e.g., customers associated with propensity scores above a threshold propensity score). Additionally, or alternatively, segmentation device 220 may determine attribute information associated with customers in the high self-service segment.

In some implementations, the attribute information may include attributes (e.g., based on and/or including customer information) common among the set of self-service customers. For example, segmentation device 220 may determine one or more attributes common among customers in the set of self-service customers.

The attribute information may include a triggering characteristic and/or a triggering event associated with a change of rate of self-service transactions (e.g., a higher frequency of self-service transactions, a lower frequency of self-service transactions, etc.). For example, segmentation device 220 may determine the triggering characteristic and/or triggering event associated with a migration of the customer from a lower self-service segment to a higher self-service segment, from a higher self-service segment to a lower self-service segment, or the like.

In some implementations, segmentation device 220 may determine the triggering characteristic based on customer information associated with a customer of the migrating self-service segment. The triggering characteristic may include a characteristic associated with a migrating customer that changes segments from a first period of time to a second period of time. For example, segmentation device 220 may determine a first set of characteristics associated with the customer having a lower self-service rate (e.g., characteristics associated with the customer before migration), and may determine a second set of characteristics associated with the customer having a higher self-service rate (e.g., characteristics associated with the customer after migration). Based on the first set of characteristics and the second set of characteristics, segmentation device 220 may determine a triggering characteristic (e.g., a characteristic associated with the migration of the customer). In some implementations, segmentation device 220 may determine one or more triggering characteristics common among the migrating self-service segment.

Segmentation device 220 may determine the triggering event based on a transaction history associated with the customer, in some implementations. For example, segmentation device 220 may determine a first set of transactions associated with a customer having a lower self-service rate (e.g., transactions before migration), and may determine a second set of transactions associated with the customer having a higher self-service rate (e.g., transactions after the migration). Based on the first set of transactions and the second set of transactions, segmentation device 220 may determine a triggering event (e.g., a transaction associated with the migration of the customer). For example, segmentation device 220 may determine that a customer migrated from the low self-service segment to the high self-service segment after the triggering event (e.g., after enrolling in electronic billing, after registering at a website associated with the business, etc.). In some implementations, segmentation device 220 may determine one or more triggering events common among the migrating self-service segment.

As further shown in FIG. 4, process 400 may include identifying a set of target customers, of the set of customers, based on the attribute information (block 440). For example, segmentation device 220 may identify target customers associated with attributes similar to attributes associated with the set of self-service customers.

In some implementations, the set of target customers may include customers likely to engage in a greater amount of future self-service transactions based on the actions of a business (e.g., based on a marketing campaign, an incentive program, an educational program, etc.). For example, the set of target customers may include customers likely to migrate from the low self-service segment to the high self-service segment after receiving a rebate, a coupon, an advertisement, or the like.

In some implementations, segmentation device 220 may determine the set of target customers based on the attribute information associated with customers having a high propensity to engage in self-service transactions. For example, segmentation device 220 may identify customers having characteristics similar to or the same as characteristics common among the self-service customers (e.g., characteristics similar to the attribute information).

The set of target customers may include a micro-segment, in some implementations. The micro-segment may include a portion of customers having similar self-service rates and sharing similar attributes. For example, segmentation device 220 may determine a micro-segment of customers associated with a high self-service rate (e.g., customers associated with the high self-service segment, customers associated with a high propensity score, etc.). Segmentation device 220 may determine the target segment by identifying a micro-segment of customers associated with a low self-service rate (e.g., customers associated with the low self-service segment, customers associated with a low propensity score, etc.) associated with attributes similar to the micro-segment of customers associated with the low self-service rates.

As further shown in FIG. 4, process 400 may include providing information that identifies the set of target customers (block 450). For example, segmentation device 220 may provide information that identifies the set of target customers to user device 230.

In some implementations, segmentation device 220 may provide information associated with a customer, such as a name, an identification number (e.g., an account number, a purchase number, etc.), an address, a telephone number, or the like. Additionally, or alternatively, segmentation device 220 may provide a portion of customer information associated with the target customers (e.g., demographic information associated with the target customers, a transaction history associated with the target customers, etc.). In some implementations, segmentation device 220 may provide the propensity scores associated with the target customers. Additionally, or alternatively, the segmentation device 220 may provide information that identifies self-service segments associated with the target customers, whether the target customers have migrated between two or more self-service segments, or the like.

In some implementations, segmentation device 220 may provide information designed to encourage the target customers to participate in self-service transactions, such as a campaign. A campaign may include different types of campaigns, such as a marketing campaign, an incentive campaign (e.g., a rebate, a promotion, a discount, etc.), an educational campaign, a survey, or the like. Additionally, or alternatively, a type of campaign may include a communication medium used to distribute the campaign, such as via e-mail, via telephone, via postal mail, etc.

In some implementations, a campaign may be associated with a result, such as a successful result or an unsuccessful result. A successful result may be determined when a customer migrates to a higher self-service segment (e.g., from a low self-service segment to a medium self-service segment). Information associated with a campaign (e.g., a result of the campaign, a campaign type, information determined from a survey campaign, etc.) may be used as customer information and/or attribute information used to further segment customers and/or determine target customers (e.g., to target with a particular campaign type). In this way, campaign results may be used in a continuous learning process.

In some implementations, segmentation device 220 may display the target information on a user interface associated with segmentation device 220. For example, segmentation device 220 may display the information identifying the target customers in the form of a table, a spreadsheet, a graph, a chart, or the like. Additionally, or alternatively, segmentation device 220 may provide the target information to user device 230, and user device 230 may display the target information.

Although FIG. 4 shows example blocks of process 400, in some implementations, process 400 may include additional blocks, different blocks, fewer blocks, and/or differently arranged blocks than those depicted in FIG. 4. Additionally, or alternatively, one or more of the blocks of process 400 may be performed in parallel. Further, one or more blocks may be omitted in some implementations.

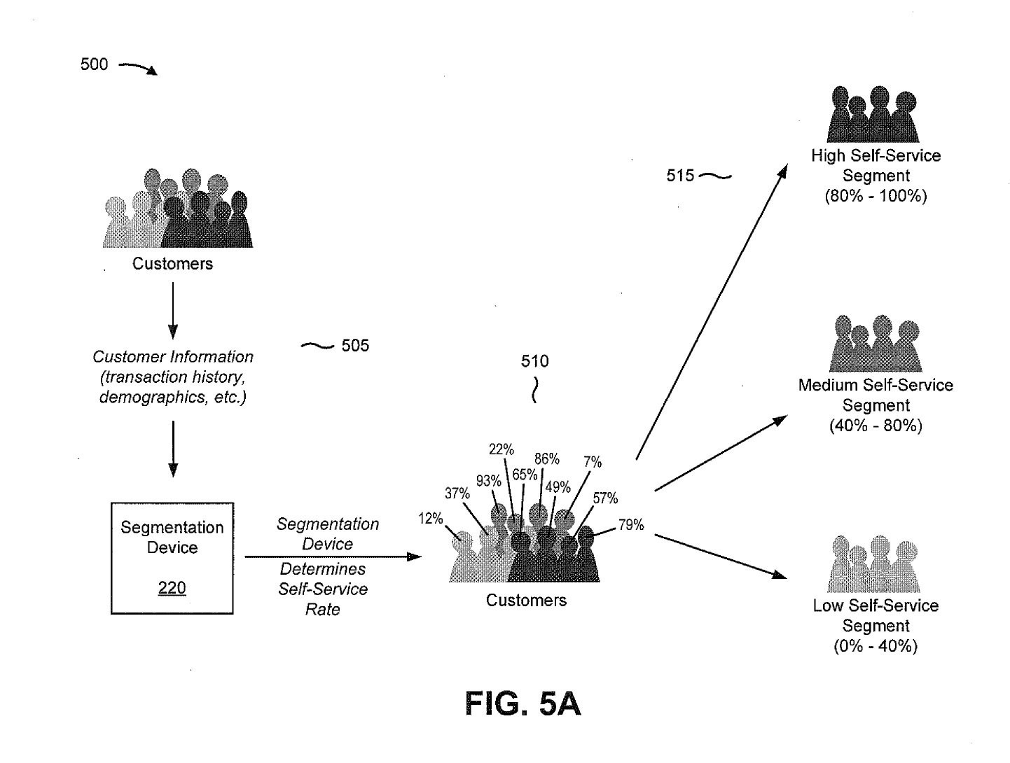

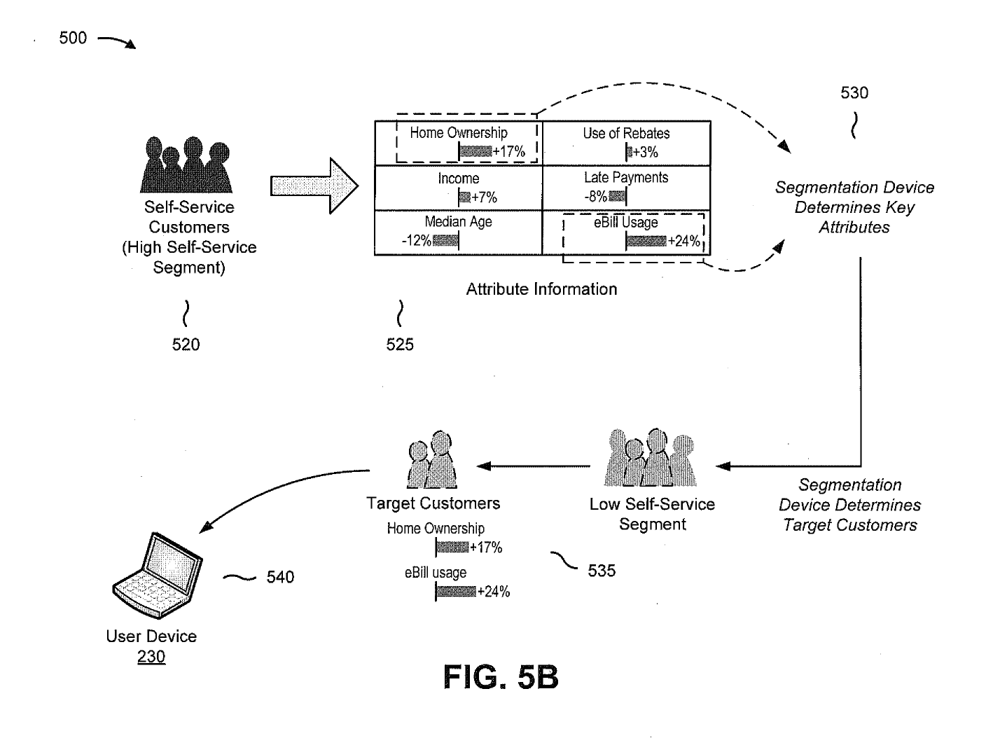

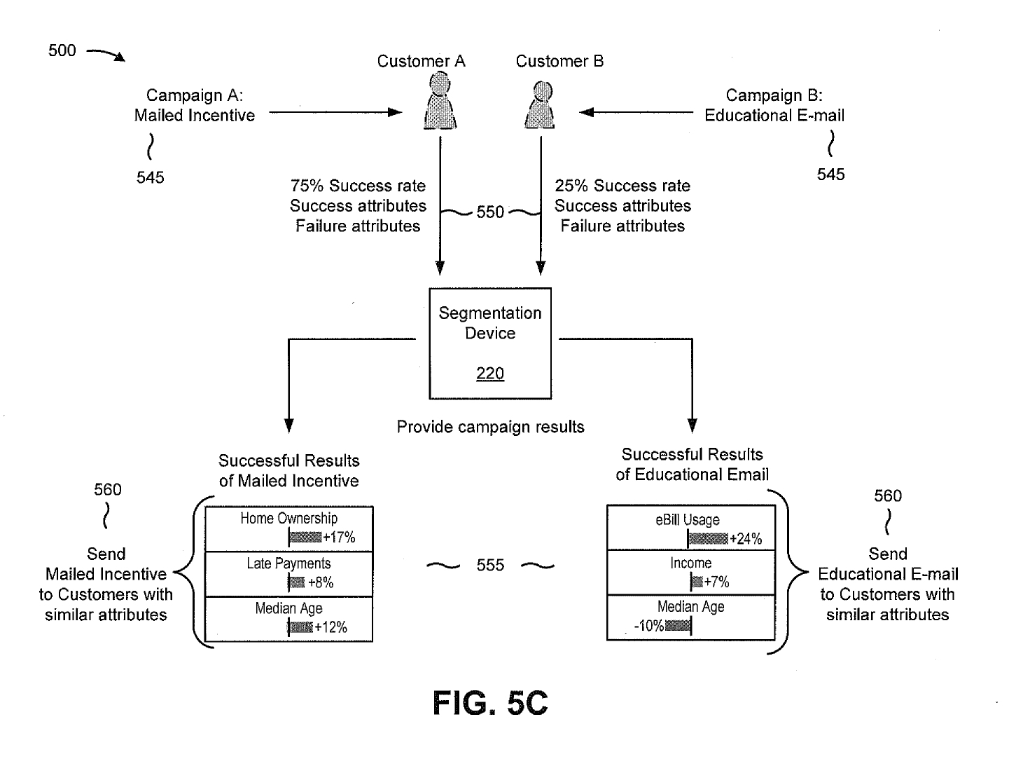

FIGS. 5A-5C are diagrams of an example implementation 500 relating to process 400 (FIG. 4). In example implementation 500, the set of customers may include customers of a utility company. Segmentation device 220 may determine a set of target customers, of the set of customers, based on attribute information associated with a set of self-service customers.

As shown in FIG. 5A, and by reference number 505, segmentation device 220 may receive customer information associated with a set of customers. The customer information may include transaction histories, demographic information, or the like. Based on the customer information, segmentation device 220 may determine self-service rates associated with the set of customers, as shown by reference number 510. For example, segmentation device 220 may determine a quantity of transactions associated with a customer (e.g., of the set of customers) during a three month period of time. Segmentation device 220 may determine a percentage of the quantity of transactions that may be characterized as self-service transactions (e.g., transactions that did not involve a human agent).

As shown by reference number 515, segmentation device 220 may segment the set of customers based on the self-service rates. For example, segmentation device 220 may determine a high self-service segment, a medium self-service segment, and a low self-service segment. The high self-service segment may include customers associated with a self-service rate equal to or above 80%. The medium self-service segment may include customers associated with a self-service rate less than 80% and greater than 40%. The low self-service segment may include customers associated with a self-service rate equal to or below 40%.

As shown in FIG. 5B, and by reference number 520, segmentation device 220 may determine the set of self-service customers based on the customer information. In some implementations, the set of self-service customers may include customers associated with the high self-service segment. Additionally, or alternatively, segmentation device 220 may determine a propensity score associated with the customers, and may determine the set of self-service customers based on the propensity score (e.g., the set of self-service customers may include customers associated with a propensity score above a threshold propensity score).

As shown by reference number 525, segmentation device 220 may determine attribute information associated with the set of self-service customers. The attribute information may include information that identifies characteristics common among the set of self-service customers, such as a home ownership rate (e.g., 17% higher than the median home ownership rate associated with the set of customers), a rebate usage rate (3% higher than the rebate usage rate associated with the set of customers), an income (7% higher than the median income rate associated with the set of customers), a rate of late payments (8% lower than the median late payment rate associated with the set of customers), an age (12% lower than the median age associated with the set of customers), and a rate of electronic bill usage (24% higher than the median electronic bill usage rate associated with the set of customers). Segmentation device 220 may determine characteristics most directly associated with a high rate of self-service (e.g., key attributes), as shown by reference number 530.

As shown by reference number 535, segmentation device 220 may determine, from the low self-service segment, a set of target customers. Segmentation device 220 may identify the set of target customers by determining a group of customers associated with a low self-service rate that share attributes with the set of self service customers. For example, the target customers may be associated with a home ownership rate and electronic bill usage similar to the set of self-service customers (e.g., the target customers may share the key attributes associated with the high self-service segment). As shown by reference number 540, segmentation device 220 may provide target information (e.g., information that identifies the target customers) to user device 230.

As shown in FIG. 5C, and by reference number 545, the target customers may receive different types of campaigns. For example, customer A may receive an incentive in the mail, and customer B may receive an educational e-mail. As shown by reference number 550, results of the campaigns may be input into segmentation device 220 (or another device) for further processing. For example, assume that the results of the mailed incentive campaign showed a 75% success rate of converting customers to a higher self-service segment, and that results of the educational e-mail campaign showed a 25% success rate of converting customers to a higher self-service segment. Furthermore, assume that segmentation device 220 receives, as further input, customer information and/or attribute information associated with customers that were successfully or unsuccessfully converted to higher self-service segments.

As shown by reference number 555, segmentation device 220 may provide campaign results, including attribute information associated with successful and/or unsuccessful customer conversions. For example, assume that customers that were successfully converted using the mailed incentive had a higher than average home ownership rate, a higher than average percentage of late payments, and a higher than average median age, as shown. Furthermore, assume that customer that were successfully converted using the educational e-mail had a higher than average enrollment in electronic billing, a higher than average income, and a lower than average age. Segmentation device 220 may provide such campaign results (e.g., via a display and/or to another device for display), and may further use such campaign results as input to further segmentation and/or determination of target customers (e.g., to determine customers to target with particular campaign types).

For example, as shown by reference number 560, segmentation device 220 may identify customers with similar attributes (e.g., within a threshold range of one or more attribute values, with attribute values above or below a median attribute value, with matching attributes, etc.) to customers that were successfully converted using the mailed incentive (e.g., customers that own a home, make a late payment once a year, whose age is between 9% and 15% older than the median age (e.g., plus or minus 3% from the attribute value of 12%), or the like). Segmentation device 220 may provide an indication that a mailed incentive is to be sent to the identified customers. As another example, segmentation device 220 may identify customers with similar attributes to customers that were successfully converted using the educational e-mail (e.g., customers that are enrolled in electronic billing, that have an annual income that is 2% to 12% higher than the median annual income (e.g., plus or minus 5% from the attribute value of 12%), whose age is between 7% and 13% younger than the median age (e.g., plus or minus 3% from the attribute value of 10%), or the like). The tolerance percentages provided above (e.g., 3%, 5%) are provided as an example, and other examples are possible and may be determined by segmentation device 220 based on, for example, user input, determining a statistically meaningful tolerance value, grouping the customers into segments, or the like.

As indicated above, FIGS. 5A-5C are provided merely as an example. Other examples are possible and may differ from what was described with regard to FIGS. 5A-5C.

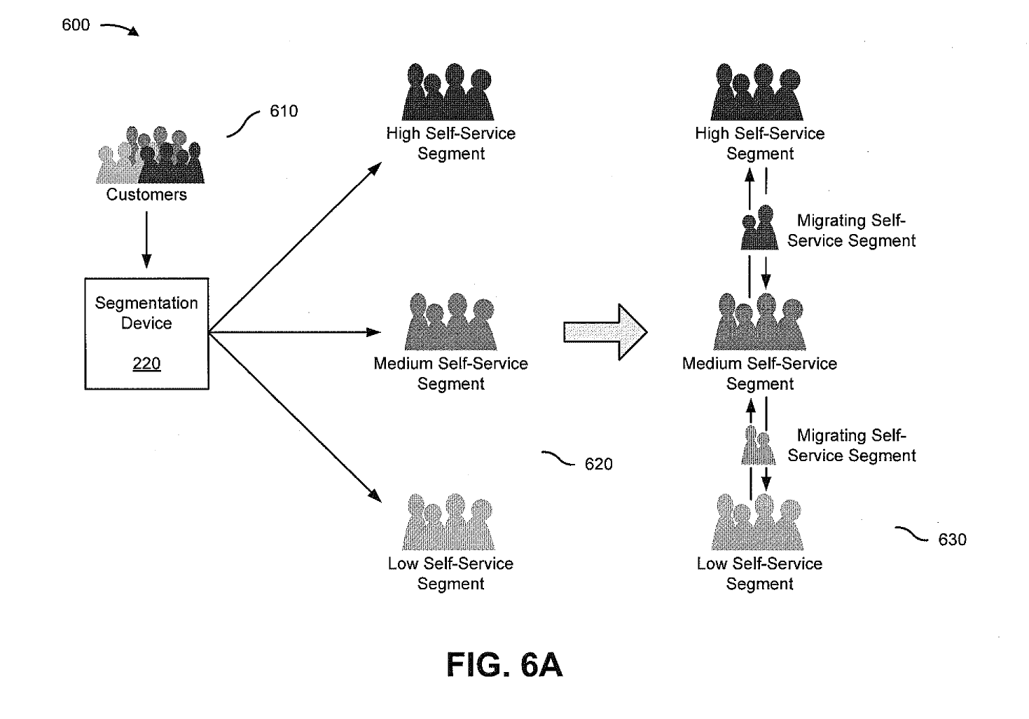

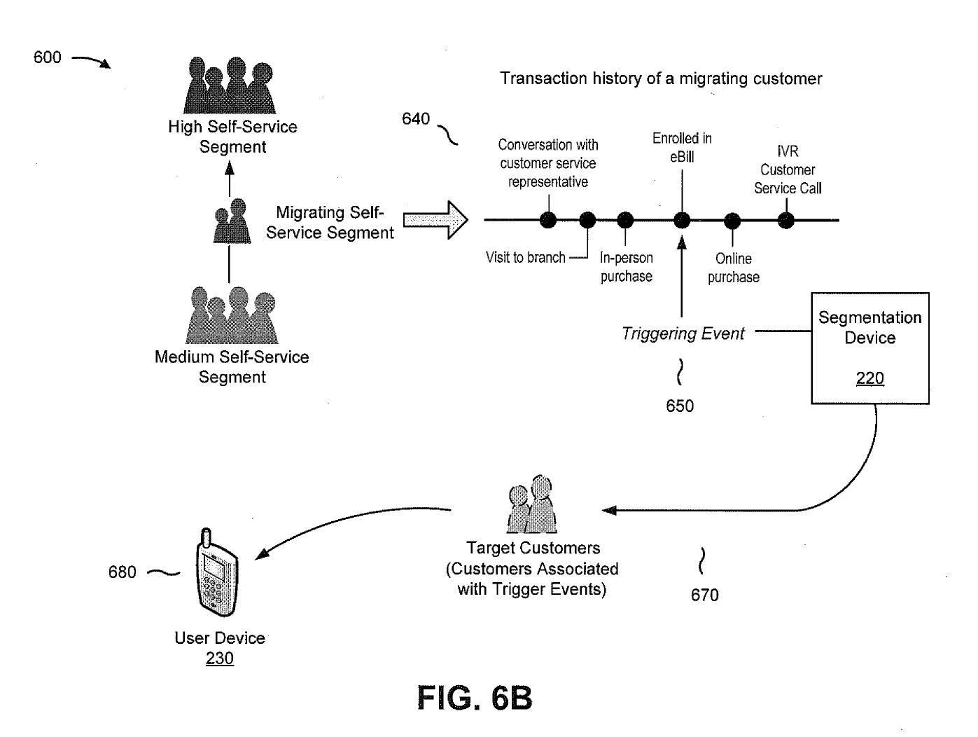

FIGS. 6A-6B are diagrams of another example implementation 600 relating to process 400 (FIG. 4). In example implementation 600, segmentation device 220 may determine the set of target customers based on identifying triggering events associated with migrating segments.

As shown in FIG. 6A, and by reference number 610, segmentation device 220 may receive customer information associated with a set of customers. As shown by reference number 620, segmentation device 220 may determine a high self-service segment, a medium self-service segment, and a low self-service segment based on the customer information (e.g., based on the transaction histories of the set of customers). As shown by reference number 630, segmentation device 220 may determine migrating self-service segments. The migrating self-service segments may include customers that migrate between self-service segments from quarter to quarter. For example, a customer may have a high self-service rate during a first quarter, and may have a medium self-service rate during a second quarter. In this manner, the customer may migrate from the high self-service segment to the medium self-service segment.

As shown in FIG. 6B, and by reference number 640, a customer associated with the migrating self-service segment may be associated with a transaction history. The transaction history may include past transactions of the customer, such as a conversation with a customer service representative, a visit to a branch, an in-person purchase, an enrollment in an electronic billing system (e.g., eBill), an online purchase, and an IVR customer service call. As shown by reference number 650, segmentation device 220 may determine a triggering event. The triggering event may include an event associated with a greater frequency of self-service transactions. For example, after enrolling in the electronic billing system, the customer may engage in a greater number of self-service transactions (e.g., an online purchase, an IVR customer service call, etc.). Segmentation device 220 may determine attribute information based on determining triggering events associated with customers in the migrating self-service segment.

As shown by reference number 670, segmentation device 220 may determine the target customers based on the triggering events. For example, the target customers may include customers associated with a low self-service rate that have recently enrolled in the electronic billing system. As shown by reference number 680, segmentation device 220 may provide information that identifies the target customers to user device 230.

As indicated above, FIGS. 6A-6B are provided merely as an example. Other examples are possible and may differ from what was described with regard to FIGS. 6A-6B.

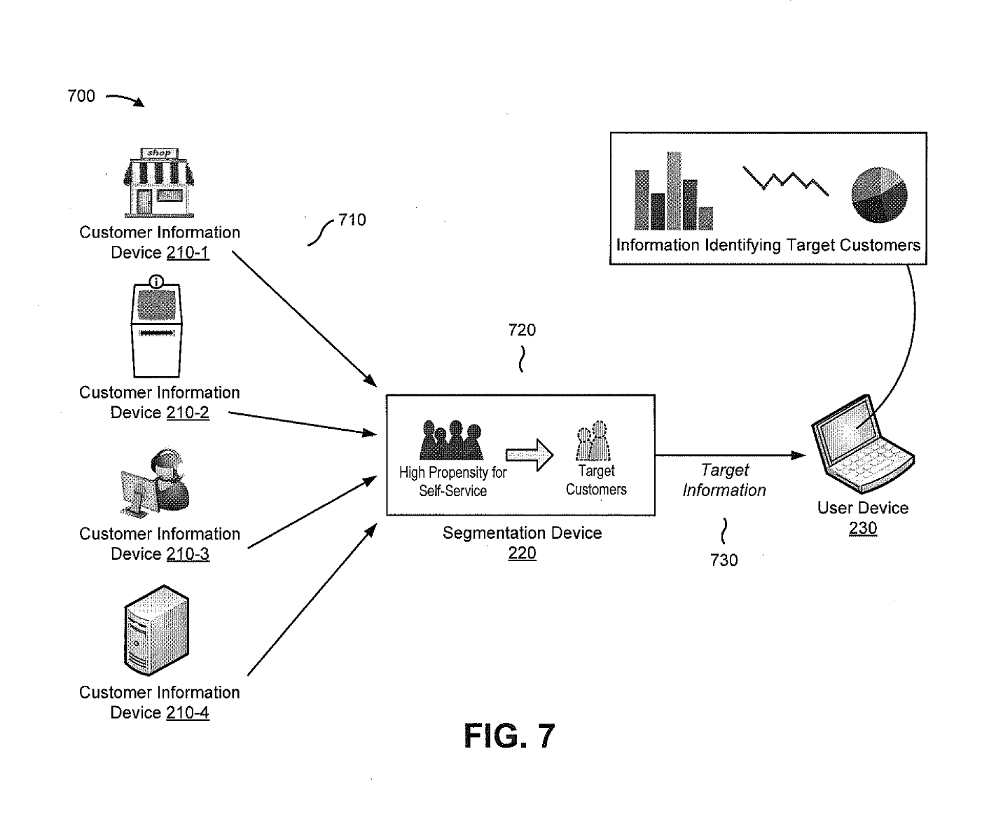

FIG. 7 is a diagram of yet another example implementation 700 relating to process 400 (FIG. 4). In example implementation 700, segmentation device 220 may receive customer information from customer information devices 210, may determine a set of target customers, and may provide target information to user device 230.

As shown by reference number 710, segmentation device 220 may receive customer information from customer information device 210-1 (e.g., a cash register in a shop), customer information device 210-2 (e.g., a kiosk), customer information device 210-3 (e.g., a call center), and customer information device 210-4 (e.g., a server). The customer information may include transactions associated with a set of customers (e.g., transactions completed via the cash register, the kiosk, and/or the call center), and/or customer profile information (e.g., customer profile information stored on a data structure associated with the server).

As shown by reference number 720, segmentation device 220 may determine self-service propensity scores associated with the set of customers. Segmentation device 220 may determine a set of self-service customers based on the self-service propensity scores (e.g., the set of self-service customers may include customers associated with propensity scores above a threshold propensity score). Segmentation device 220 may determine attribute information associated with the self-service customers, and may determine target customers based on the attribute information.

As shown by reference number 730, segmentation device 220 may determine target information associated with the target customers. The target information may include information that identifies the target customers, self-service rates associated with the target customers, propensity scores associated with the target customers, transactions histories associated with the target customers, or the like. Segmentation device 220 may provide the target information to user device 230. User device 230 may display the target information on a display associated with user device 230. A user associated with user device 230 may determine a marketing campaign, an incentive program, an education program, or the like based on the target information. The marketing campaign, the incentive program, the education program, or the like may be used to entice customers to more frequently use self-service transactions.

As indicated above, FIG. 7 is provided merely as an example. Other examples are possible and may differ from what was described with regard to FIG. 7.

Implementations described herein may allow a segmentation device to determine target customers most likely to engage in a higher frequency of self-service transactions as the result of a marketing campaign, incentive program, education program, or the like.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in conjunction with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Some implementations have been described herein with reference to high and low. As used herein, high is measured relative to low. High is typically greater than some threshold, and low is typically less than some threshold.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive customer information associated with a plurality of customers;
determine a plurality of self-service customers, of the plurality of customers, based on the customer information,
the plurality of self-service customers being associated with a likelihood, of participating in future self-service transactions, that is greater than a first threshold;
determine attribute information associated with the plurality of self-service customers;
identify a plurality of target customers, of the plurality of customers, based on the attribute information,
the plurality of target customers being associated with a likelihood, of participating in future self-service transactions, that is less than a second threshold;
determine target information based on identifying the plurality of target customers,
the target information including information that identifies the plurality of target customers; and
provide the target information.

2. The device of claim 1, where the one or more processors, when determining the plurality of self-service customers, are further to:
determine a plurality of propensity scores associated with the plurality of customers,
a propensity score, of the plurality of propensity scores, being associated with an estimate of a likelihood that a customer, of the plurality of customers, will engage in a future self-service transaction; and
determine the plurality of self-service customers based on the plurality of propensity scores.

3. The device of claim 1, where the one or more processors, when determining the plurality of self-service customers, are further to:
determine the plurality of self-service customers using a statistical model.

4. The device of claim 1, where the one or more processors, when determining the plurality of self-service customers, are further to:
determine a plurality of self-service rates associated with the plurality of customers,
the plurality of self-service rates being associated with a plurality of self-service transactions of a plurality of transactions;
determine a segment of customers, of the plurality of customers, associated with a self-service rate, of the plurality of self-service rates, that satisfies a threshold; and
determine the plurality of self-service customers based on the segment of customers.

5. The device of claim 1, where the one or more processors, when determining the plurality of self-service customers, are further to:
determine a migrating segment,
the migrating segment being associated with a segment of the plurality of customers that migrate between two or more self-service segments; and
determine the plurality of self-service customers based on the migrating segment;
where the one or more processors, when determining the attribute information, are further to:
determine a triggering event associated with the migrating segment,
the triggering event including an event related to a factor for migrating.

6. The device of claim 1, where the one or more processors, when identifying the plurality of target customers, are further to:
determine a plurality of attributes associated with the plurality of target customers; and
identify the plurality of target customers based on determining that the plurality of attributes associated with the plurality of target customers is similar to the attribute information.

7. The device of claim 1, where the target information includes at least one of:
a name associated with a customer, of the plurality of customers;
a propensity score associated with the customer,
the propensity score being associated with a likelihood that the customer will engage in a future self-service transaction;
a self-service rate associated with the customer,
the self-service rate being a measure of how frequently the customer participates in a self-service transaction; or
a transaction history associated with the customer.

8. A computer-readable medium storing instructions, the instructions comprising:
one or more instructions that, when executed by one or more processors, cause the one or more processors to:
receive customer information associated with a plurality of customers;
determine a plurality of self-service customers, of the plurality of customers, based on the customer information,
the plurality of self-service customers being associated with a plurality of self-service rates that is greater than a first threshold,
the plurality of self-service rates being associated with a plurality of self-service transactions of a plurality of transactions;
determine attribute information associated with the plurality of self-service customers;
identify a plurality of target customers, of the plurality of customers, based on the attribute information,
the plurality of target customers being associated with a likelihood, of participating in future self-service transactions, that is less than a second threshold;
determine target information based on identifying the plurality of target customers,
the target information including information that identifies the plurality of target customers; and
provide the target information.

9. The computer-readable medium of claim 8, where the one or more instructions, that cause the one or more processors to determine the plurality of self-service customers, further cause the one or more processors to:
determine a plurality of propensity scores associated with the plurality of customers,
a propensity score, of the plurality of propensity scores, being associated with an estimate of a likelihood that a customer, of the plurality of customers, will engage in a future self-service transaction; and
determine the plurality of self-service customers based on the plurality of propensity scores.

10. The computer-readable medium of claim 8, where the one or more instructions, that cause the one or more processors to determine the plurality of self-service customers, further cause the one or more processors to:
determine the plurality of self-service customers using a statistical model.

11. The computer-readable medium of claim 8, where the one or more instructions, that cause the one or more processors to determine the plurality of self-service customers, further cause the one or more processors to:
determine a likelihood of participating in future self-service transactions associated with the plurality of customers;
determine a segment of customers, of the plurality of customers, associated with the likelihood, of participating in future self-service transactions, that satisfies a threshold; and
determine the plurality of self-service customers based on the segment of customers.

12. The computer-readable medium of claim 8, where the one or more instructions, that cause the one or more processors to determine the plurality of self-service customers, further cause the one or more processors to:
determine a migrating segment,
the migrating segment being associated with a segment of the plurality of customers that migrate between two or more self-service segments; and
determine the plurality of self-service customers based on the migrating segment,
where the one or more instructions, that cause the one or more processors to determine the attribute information, further cause the one or more processors to:
determine a triggering event associated with the migrating segment,
the triggering event including an event related to a factor for migrating between the two or more self-service segments.

13. The computer-readable medium of claim 8, where the one or more instructions, that cause the one or more processors to identify the plurality of target customers, further cause the one or more processors to:
determine a plurality of attributes associated with the plurality of target customers; and
identify the plurality of target customers based on determining that the plurality of attributes associated with the plurality of target customers is similar to the attribute information.

14. The computer-readable medium of claim 8, where the target information includes at least one of:
a name associated with a customer of the plurality of customers;
a propensity score associated with the customer,
the propensity score being associated with a likelihood that the customer will engage in a future self-service transaction;
a self-service rate associated with the customer,
the self-service rate being a measure of how frequently the customer participates in a self-service transaction; or
a transaction history associated with the customer.

15. A method, comprising:
receiving, by one or more devices, customer information associated with a plurality of customers;
determining, by the one or more devices, a plurality of self-service customers, of the plurality of customers, based on the customer information,
the plurality of self-service customers being associated with a likelihood, of participating in future self-service transactions, that satisfies a threshold;
determining, by the device, attribute information associated with the plurality of self-service customers;
identifying, by the one or more devices, a plurality of target customers, of the plurality of customers, based on the attribute information,
the plurality of target customers being associated with a likelihood, of participating in future self-service transactions, that does not satisfy a second threshold;
determining, by the one or more devices, target information based on identifying the plurality of target customers,
the target information including information relating to the plurality of target customers; and
providing, by the one or more devices, the target information.

16. The method of claim 15, where determining the plurality of self-service customers further comprises:
determining a plurality of propensity scores associated with the plurality of customers,
a propensity score, of the plurality of propensity scores, being associated with an estimate of a likelihood that a customer, of the plurality of customers, will engage in a future self-service transaction; and
determining the plurality of self-service customers based on the plurality of propensity scores.

17. The method of claim 15, where determining the plurality of self-service customers further comprises:
determining a plurality of self-service rates associated with the plurality of customers,
the plurality of self-service rates being associated with a plurality of self-service transactions;
determining a segment of customers, of the plurality of customers, associated with a self-service rate, of the plurality of self-service rates, that satisfies a threshold; and
determining the plurality of self-service customers based on the segment of customers.

18. The method of claim 15, where determining the plurality of self-service customers further comprises:
determining a migrating segment,
the migrating segment being associated with a segment of the plurality of customers that migrate from a first group to a second group,
the first group being associated with first self-service segment,
the second group being associated with a second self-service segment,
the second self-service segment being different from the first self-service segment; and
determining the plurality of self-service customers based on the migrating segment;
where determining the attribute information further comprises:
determining a triggering event associated with the migrating segment,
the triggering event including an event related to a factor for migrating from the first group to the second group.

19. The method of claim 15, where identifying the plurality of target customers further comprises:
determining a plurality of attributes associated with the plurality of target customers; and
identifying the plurality of target customers based on determining that the plurality of attributes associated with the plurality of target customers is similar to the attribute information.

20. The method of claim 15, where the target information includes at least one of:
a name associated with a customer of the plurality of customers;
a propensity score associated with the customer,
the propensity score being associated with a likelihood that the customer will engage in a future self-service transaction;
a self-service rate associated with the customer,
the self-service rate being a measure of how frequently the customer participates in a self-service transaction; or
a transaction history associated with the customer.
